(19) United States
(12) Patent Application Publication
(10) Pub. No.: US 2013/0103772 A1
(43) Pub. Date: Apr. 25, 2013

(54) METHOD FOR AN INSTANT MESSAGING SYSTEM AND INSTANT MESSAGING SYSTEM

(71) Applicant: International Business Machines Corporation, Armonk, NY (US)

(72) Inventors: MING TUNG LAU, POKFULAM (HK); WAI MAN LEE, POKFULAM (HK)

(73) Assignee: INTERNATIONAL BUSINESS MACHINES CORPORATION, ARMONK, NY (US)

(21) Appl. No.: 13/659,472

(22) Filed: Oct. 24, 2012

(30) Foreign Application Priority Data
Oct. 25, 2011 (CN) 201110326750.4

(51) Int. Cl. G06F 15/16

(52) U.S. Cl. 709/206

(57) ABSTRACT

Processing for an Instant Messaging IM system includes obtaining contents of an IM session, identifying participants of the IM session, extracting, using a central processing unit, keywords of the IM session from the contents, and associating the keywords of the IM session, the participants of the IM session with the corresponding IM session.

### CROSS-REFERENCE TO RELATED APPLICATIONS

This application claims the benefit of China Application Number 201110326750.4 filed on Oct. 25, 2011, which is fully incorporated herein by reference.

### BACKGROUND

An Instant Messaging (IM for short) system refers to a system enabling people to communicate online in real time. It is a technology enabling people to identify online users and communicate with them in real time. Most existing IM systems are based on instant session messages. Generally, the initiator of an IM session sends an IM session request to a participant with whom he wants to communicate, and after the participant accepts the session request, creates an IM session between the initiator and the participant. Since in the existing IM system, instant session messages are usually isolated, it is usually very difficult for the participants of an IM session to obtain effective information from a large amount of IM sessions. That is to say, the efficiency of obtaining effective information from the existing IM system is usually very low.

### BRIEF SUMMARY

According to an embodiment of the present disclosure, a method for an IM system is provided, comprising: obtaining contents of an IM session; identifying participants of the IM session; extracting keywords of the IM session from the contents; and associating the keywords of the IM session, the participants of the IM session with the corresponding IM session.

According to an embodiment of the present disclosure, a system for IM includes a central processing unit programmed to initiate executable operations. The executable operations include obtaining contents of an IM session, identifying participants of the IM session, extracting keywords of the IM session from the contents, and associating the keywords of the IM session, the participants of the IM session with the corresponding IM session.

According to an embodiment of the present disclosure, a computer program product for an Instant Messaging (IM) system includes a computer readable storage medium having program code stored thereon. The program code is executable by a central processing unit to perform a method. The method includes obtaining contents of an IM session, identifying participants of the IM session, extracting keywords of the IM session from the contents, and associating the keywords of the IM session, the participants of the IM session with the corresponding IM session.

### BRIEF DESCRIPTION OF THE SEVERAL VIEWS OF THE DRAWINGS

The present disclosure may be better understood by referring to the following description when read in conjunction with the accompanying drawings, wherein the same or similar reference numerals are used to denote the same or similar components throughout the accompanying drawings. The accompanying drawings and the following detailed description are included in the specification and form part thereof, and are used for further exemplarily illustrating preferred embodiments of this disclosure and interpreting the principles and advantages of this disclosure, in which:

FIG. 1 shows a block diagram of an exemplary computing system 100 suitable for implementing an embodiment of the present disclosure;

FIG. 2 shows a flow chart of a method 200 for an IM system according to an embodiment of this disclosure;

FIG. 3 shows a block diagram of an IM system 300 according to an embodiment of the present disclosure;

FIGS. 4a-4b respectively shows an example of outputting associations in a graph.

### DETAILED DESCRIPTION

The present disclosure relates to an instant messaging system. More particularly, the present disclosure relates to a method for an instant messaging system and an instant messaging system.

In the following are described embodiments according to the present disclosure in conjunction with the accompanying drawings.

The terminology used herein is for the purpose of describing particular embodiments only and is not intended to limit of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims are intended to include any structure, material, or act for performing the function in combination with other claimed elements as specifically claimed. The description of the present invention has been presented for purposes of illustration and description, but is not intended to be exhaustive or limit the invention to the form disclosed. Many modifications and variations will be apparent to those of ordinary skill in the art without departing from the scope and spirit of the invention. The embodiment was chosen and described in order to best explain the principals of the invention and its practical applications, and to enable those of ordinary skill in the art to understand the invention for various embodiments with various modifications suited to the particular use contemplated.

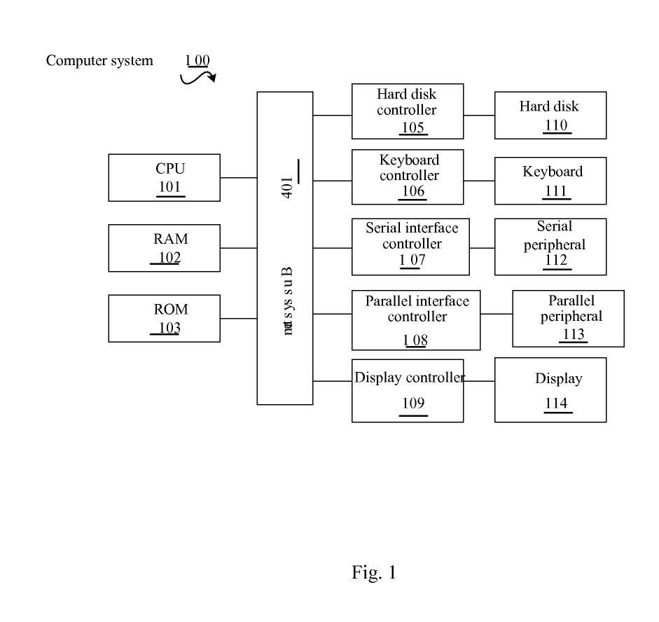

FIG. 1 shows a block diagram of an exemplary computing system 100 adapted to implement the embodiment of the present disclosure. As shown in FIG. 1, computer system 100 may include: CPU (central processing unit) 101, RAM (Random Access Memory) 102, ROM (Read-Only Memory) 103, system bus 104, hard disk controller 105, keyboard controller 106, serial interface controller 107, parallel interface controller 108, display controller 109, hard disc 110, keyboard 111, serial peripheral 112, parallel peripheral 113 and a display 114. Among above devices, CPU 101, RAM 102, ROM 103, hard disc controller 105, keyboard controller 106, serial controller 107, parallel controller 108 and display controller 109 are coupled with system bus 104. Hard disc 110 is coupled to hard disc controller 105; keyboard 111 is coupled to the keyboard controller 106; serial peripheral 112 is coupled to the serial interface controller 107; parallel peripheral 113 is coupled to the parallel interface controller 108, and display 114 is coupled to display controller 119. It is to be appreciated that the structural block diagram of FIG. 1 is merely shown for illustration, rather than limitation to the scope of the disclosure. In some cases, some devices may be added or removed based on specific situations.

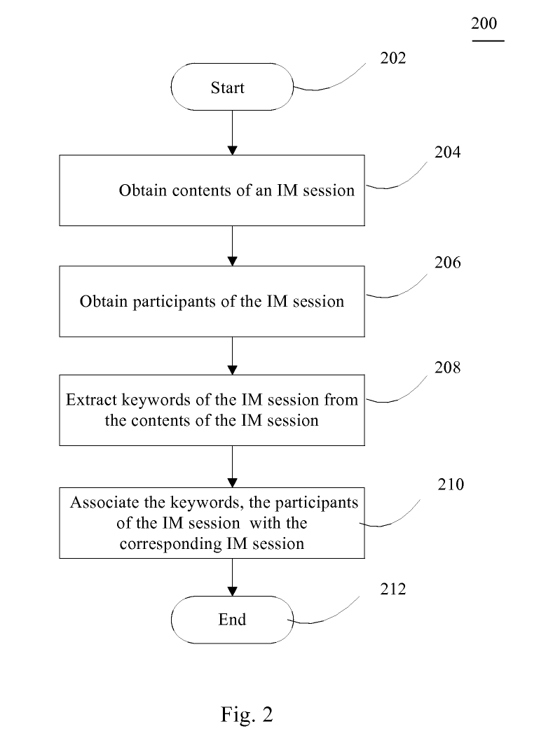

FIG. 2 shows a flow chart of a method 200 for an IM system according to an embodiment of this disclosure.

As shown in FIG. 2, method 200 for an IM system according to an embodiment of the present disclosure starts from step 202. Next, method 200 proceeds to step 204, in which contents of an IM session are obtained. The contents of the IM session may be obtained via the server of the IM system, or via a client of the IM system. Generally, the contents of the IM sessions of which all the permissions are open to all can be obtained. For a particular participant, the contents of all the IM sessions in which he participates can be obtained. Further, the contents of the IM sessions in a social network where the specific participant is can also be obtained.

Next, method 200 proceeds to step 206, in which the participants of the IM session are obtained. The participants of the IM session can be obtained via the server of the IM system, or via a client of the IM system. Generally, the participants of the IM sessions of which all the permissions are open to all can be obtained. For a particular participant, the other participants of all the IM sessions in which he participates can be obtained. Further, the participants of the IM sessions in a social network where the specific participant is can also be obtained.

Next, method 200 proceeds to step 208, wherein the keywords of the IM session are extracted from the obtained contents of the IM session. Any approaches in the prior art can be used to extract the keywords of the IM session. For example, the keywords of the IM session can be extracted by simply removing commonly used words like “and”, “or”, “it”, “they”, “furthermore”, etc., from the obtained contents of the IM session. Similarly, for languages like Chinese, first the contents of the IM session can be divided into respective words by a word segmentation technology, and then the keywords of the IM session can be extracted by removing commonly used words like “ [symbol] ”, “ [symbol] ”, “ [symbol] ”, “ [symbol] ”, etc. Further, the keywords can be extracted from the obtained contents of the IM session by a text mining technology. For example, named entities in the obtained IM session contents can be obtained by a named entity identification technology, and the named entities can be taken as keywords of the IM session. Which approach to use specifically for extracting the keywords of the IM session is not a problem to be resolved by the present disclosure, and is not described in detail herein.

Next, method 200 proceeds to step 210, in which the keywords of the IM session, the participants of the IM session are associated with the corresponding IM session. Such association may be stored in the form of a data table, wherein the entry of each data item may be the ID of the IM session, which has one or more attributes, including the keywords of the IM session, the participants of the IM session, etc. Of course, such associations may also be stored in any other forms in the prior art.

Next, method 200 proceeds to step 212 to end.

Above is described a method 200 for an IM system according to an embodiment of the present disclosure. According to an embodiment of the present disclosure, the method for an IM system may further comprise: obtaining access permissions of the IM session; and associating the access permissions of the IM session with the corresponding IM session. In default, for an IM session open to all, its access permissions are being accessible to anyone. For an IM session open only to the participants of the IM session, its access permissions are limited to the participants of the IM session only. In addition, the access permissions of an IM session may be for a group, i.e., the access permissions thereof are limited to the people in the group, etc. According to the above embodiment of the present disclosure, the access permissions of the IM session are further obtained and the access permissions of the IM session are associated with the corresponding IM session. Such corresponding relationship can be stored in the form of a data table, wherein the entry of each data item may be the ID of the IM session, which, besides the attributes of the keywords of the IM session, the participants of the IM session, etc., also has the attribute of the permissions of the IM session.

According to another embodiment of the present disclosure, the method for an IM system further comprises: clustering IM sessions, wherein each IM session cluster includes at least one IM session and the contents of the at least one IM session have a related topic. The IM sessions can be clustered by a text mining technology, e.g., the IM sessions can be clustered by using text structure analysis, text abstract, text correlation analysis, text distribution analysis, etc., and the obtained result is at least one IM session cluster. Each of the at least one IM session cluster includes at least one IM session, and the contents of the at least one IM session have a related topic. Taking a simple example, if there are three IM sessions, wherein the contents of IM session 1 are about donation to dropout children, the contents of IM session 2 are about providing legal aid, and the contents of IM session 3 are about blood donation. It is found by using a text mining technology that the contents of IM sessions 1-3 are all related to volunteer activities, thus IM sessions 1-3 are clustered together to form an IM session cluster, and the contents of the IM sessions forming the IM session cluster have the related topic of “volunteer activities”. As for how to carry out text mining, it is prior art, and is not described in detail herein.

According to another embodiment of the present disclosure, the method for an IM system may further comprise: for at least one IM session cluster, extracting keywords of the IM session cluster; taking the participants of at least one IM session included in the IM session cluster as participants of the IM session cluster. The keywords of the at least one IM session included in the IM session cluster can be used as keywords of the IM session cluster, or keywords can be extracted again from the contents of the at least one IM session included in the IM session cluster as keywords of the IM session cluster. Further, the method for an IM system may further comprises: associating the keywords of the IM session cluster, the participants of the IM session cluster with the IM session cluster. Such an association can be stored in the form of a data table, wherein the entry of each data item can be the ID of the IM session cluster, which has one or more attributes, including the keywords of the IM session cluster, the participants of the IM session cluster, etc. Of course, such an association can also be stored in any other forms in the prior art.

According to an embodiment of the present disclosure, the method for an IM system further comprises: for at least one IM session cluster, obtaining access permissions of the IM session cluster; and associating the access permissions of the IM session cluster with the corresponding IM session cluster. In default, the permissions of an IM session depends on the strictest permissions of all the IM sessions forming the IM session cluster. Of course, the permissions for each IM session cluster can also be set again for it. Such an association can be stored in the form of a data table, wherein the entry of each data item can be the ID of the IM session cluster, which, besides the attributes of the keywords of the IM session cluster and the participants of the IM session cluster, also has the attribute of the permissions of the IM session cluster.

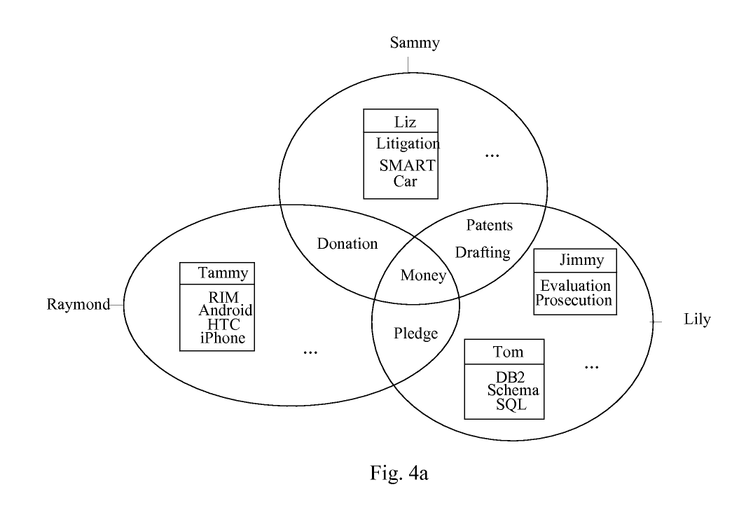

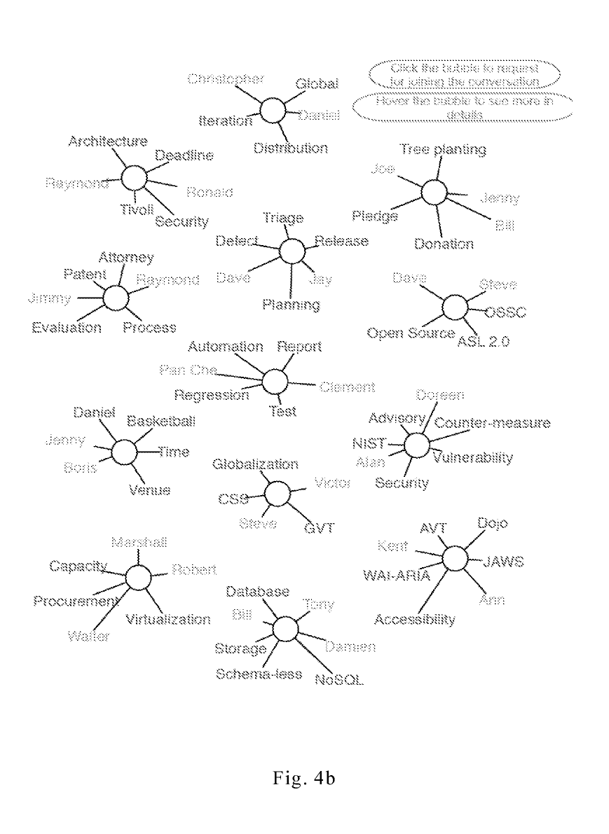

According to an embodiment of the present disclosure, the method for an IM system may further comprises: visually outputting the association between the keywords of the IM session, the participants of the IM session and the corresponding IM session. For example, the above association can be visually output in a graph or list, or the above association can be output by any visualization method in the prior art. FIG. 4a simply shows an example of outputting the above association in a graph, wherein each circle represents a participant of the IM session, and the intersection of two circles represent the keywords of the IM session between two participants, and the rectangles in a circle represent other participants performing IM sessions with the participant represented by the circle and the keywords of the IM sessions.

According to an embodiment of the present disclosure, the method for an IM system may further comprise: visually outputting the association between the keywords of the IM session cluster, the participants of the IM session cluster and the corresponding IM session cluster. For example, the above association can be outputted in a graph or list; of course, any visualization method in the prior art may be used to output the above association. FIG. 4b simply shows an example of outputting the above association in a graph, wherein each star represents an IM session cluster, the light-colored words represent the participants of the IM session clusters, and the dark-colored words represent the keywords of the IM session clusters.

It is noted that FIGS. 4a-4b are merely examples, and the association between the keywords of the IM session, the participants of the IM session and the corresponding IM session as well as the association between the keywords of the IM session cluster, the participants of the IM session cluster and the corresponding IM session cluster can be output visually in any other manners.

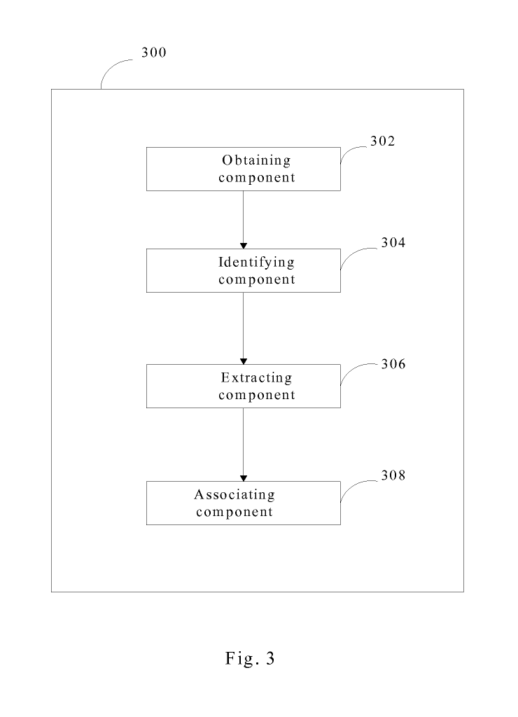

Referring to FIG. 3 below, it shows a block diagram of an IM system 300 of an embodiment of the present disclosure. The IM System 300 according to an embodiment of the present disclosure comprises: an obtaining component 302 configured to obtain contents of an IM session; an identifying component 304 configured to identify participants of the IM session; an extracting component 306 configured to extract keywords of the IM session from the contents; and an associating component 308 configured to associate the keywords of the IM session, the participants of the IM session with the corresponding IM session.

According to another embodiment of the present disclosure, the obtaining component is further configured to obtain access permissions of the IM session; and the associating component is further configured to associate the access permissions of the IM session with the corresponding IM session.

According to still another embodiment of the present disclosure, IM system 300 further comprises a clustering component configured to cluster IM sessions, wherein each IM session cluster comprises at least one IM session and the contents of the at least one IM session have a related topic. For the at least one IM session cluster: the extracting component is further configured to extract the keywords of the IM session cluster; the associating component is further configured to take the participants of at least one IM session included in the IM session cluster as participants of the IM session cluster. Extracting the keywords of the IM session cluster comprises: taking the keywords of the at least one IM session included in the IM session cluster as keywords of the IM session cluster. For the at least one IM session cluster, the associating component is further configured to associate the keywords of the IM session cluster, the participants of the IM session cluster with the IM session cluster. For the at least one IM session cluster, the obtaining component is further configured to obtain the access permissions of the IM session cluster; the associating component is further configured to associate the access permissions of the IM session cluster with the IM session cluster.

According to an embodiment of the present disclosure, IM system 300 further comprises an outputting component configured to visually output the association between the keywords of the IM session, the participants of the IM session and the corresponding IM session. According to an embodiment of the present disclosure, IM system 300 further comprises an outputting component configured to visually output the association between the keywords of the IM session cluster, the participants of the IM session cluster and the corresponding IM session cluster.

By using the above one or more embodiments provided by embodiments of the present disclosure, participants of an IM session can quickly and effectively obtain effective information from the large amount of IM sessions, thus increasing the efficiency of obtaining information.

Above is described in detail the method and system according the embodiments of the present disclosure. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as component of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wired, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It should be further pointed out that in the apparatus and method of the present disclosure, obviously, the components or steps can be decomposed and/or recombined. Such decomposition and/or recombination shall be viewed as equivalent solutions of the present disclosure. Moreover, the steps executing the above series of processing can be performed naturally in the described time sequence, but they may not necessarily be performed in the time sequence. Some steps can be performed in parallel or independently from each other.

Although the present disclosure and its advantages have been described in detail, it should be understood that various changes, replacements and alterations can be made without departing from the sprints and scope of the present disclosure as defined by the appended claims. Moreover, the terms in the present application, “comprises,” “comprising,” or any other variants are intended to cover non-exclusive inclusion, so that the process, method, article or device comprising a series of elements not only include these elements, but also include other elements not explicitly stated, or elements inherent to the process, method, article or device. Without more limitation, the element defined by the phrase “comprising a” does not exclude the existence of other identical elements in the process, method, article or device comprising the element.

What is claimed is:

1. A method for an Instant Messaging IM system, comprising:
obtaining contents of an IM session;
identifying participants of the IM session;
extracting, using a central processing unit, keywords of the IM session from the contents; and
associating the keywords of the IM session, the participants of the IM session with the corresponding IM session.

2. The method of claim 1, further comprising:
obtaining access permissions of the IM session; and
associating the access permissions of the IM session with the corresponding IM session.

3. The method of claim 1, further comprising:
clustering IM sessions, wherein each IM session cluster comprises at least one IM session and the contents of the at least one IM session have a related topic.

4. The method of claim 3, wherein for at least one IM session cluster:
extracting keywords of the IM session cluster;
taking the participants of at least one IM session included in the IM session cluster as participants of the IM session cluster.

5. The method of claim 4, wherein extracting keywords of the IM session cluster comprises:
taking the keywords of at least one IM session included in the IM session cluster as keywords of the IM session cluster.

6. The method of claim 4, wherein for at least one IM session cluster:
associating the keywords of the IM session cluster, the participants of the IM session cluster with the IM session cluster.

7. The method of claim 3, wherein for at least one IM session cluster:
obtaining access permissions of the IM session cluster;
associating the access permissions of the IM session cluster with the IM session cluster.

8. The method of claim 1, further comprising:
visually outputting the association between the keywords of the IM session, the participants of the IM session and the corresponding IM session.

9. The method of claim 6, further comprising:
visually outputting the association between the keywords of the IM session cluster, the participants of the IM session cluster and the corresponding IM session cluster.

10. The method of claim 1, wherein:
the participants of the IM session come from a social network.

11. A system for an Instant Messaging (IM) system, comprising:
a central processing unit programmed to initiate executable operations comprising:
obtaining contents of an IM session;
identifying participants of the IM session;
extracting keywords of the IM session from the contents; and
associating the keywords of the IM session, the participants of the IM session with the corresponding IM session.

12. The system of claim 11, wherein the central processing unit is further programmed to initiate executable operations comprising:
obtaining access permissions of the IM session; and
associating the access permissions of the IM session with the corresponding IM session.

13. The system of claim 11, wherein the central processing unit is further programmed to initiate executable operations comprising:
clustering IM sessions, wherein each IM session cluster comprises at least one IM session and the contents of the at least one IM session have a related topic.

14. The system of claim 13, wherein for at least one IM session cluster the central processing unit is further programmed to initiate executable operations comprising:
extracting keywords of the IM session cluster;
taking the participants of at least one IM session included in the IM session cluster as participants of the IM session cluster.

15. The system of claim 14, wherein extracting keywords of the IM session cluster comprises:
taking the keywords of at least one IM session included in the IM session cluster as keywords of the IM session cluster.

16. The system of claim 14, wherein for at least one IM session cluster the central processing unit is further programmed to initiate executable operations comprising:
associating the keywords of the IM session cluster, the participants of the IM session cluster with the IM session cluster.

17. The system of claim 13, wherein for at least one IM session cluster the central processing unit is further programmed to initiate executable operations comprising:
obtaining access permissions of the IM session cluster;
associating the access permissions of the IM session cluster with the IM session cluster.

18. The system of claim 11, wherein the central processing unit is further programmed to initiate executable operations comprising:
visually outputting the association between the keywords of the IM session, the participants of the IM session and the corresponding IM session.

19. The system of claim 16, wherein the central processing unit is further programmed to initiate executable operations comprising:
visually outputting the association between the keywords of the IM session cluster, the participants of the IM session cluster and the corresponding IM session cluster.

20. The system of claim 11, wherein:
the participants of the IM session come from a social network.

21. A computer program product for an Instant Messaging (IM) system, the computer program product comprising a computer readable storage medium having program code stored thereon, the program code executable by a central processing unit to perform a method comprising:
obtaining contents of an IM session;
identifying participants of the IM session;
extracting keywords of the IM session from the contents; and
associating the keywords of the IM session, the participants of the IM session with the corresponding IM session.

22. The computer program product of claim 21, wherein the method further comprises:
obtaining access permissions of the IM session; and
associating the access permissions of the IM session with the corresponding IM session.

23. The computer program product of claim 21, wherein the method further comprises:
clustering IM sessions, wherein each IM session cluster comprises at least one IM session and the contents of the at least one IM session have a related topic.

24. The computer program product of claim 23, wherein for at least one IM session cluster the method further comprises:
extracting keywords of the IM session cluster;
taking the participants of at least one IM session included in the IM session cluster as participants of the IM session cluster.

25. The computer program product of claim 24, wherein extracting keywords of the IM session cluster comprises:
taking the keywords of at least one IM session included in the IM session cluster as keywords of the IM session cluster.
